(19) United States
(12) Patent Application Publication
(10) Pub. No.: US 2026/0088912 A1
(43) Pub. Date: Mar. 26, 2026

(54) QUANTUM SYSTEM AND METHOD OF OPERATION

(71) Applicant: QUBIC INC., Sherbrooke (CA)

(72) Inventors: Jérôme BOURASSA, Sherbrooke (CA); Christopher M. WILSON, Waterloo (CA)

(21) Appl. No.: 19/120,922

(22) PCT Filed: Oct. 24, 2024
(86) PCT No.: PCT/CA2023/051410

§ 371 Date: Apr. 14, 2025

Related U.S. Application Data
(60) Provisional application No. 63/419,004, filed on Oct. 25, 2022.

(51) Int. Cl. H04B 10/70; H04B 1/26

(52) U.S. Cl. CPC H04B 10/70; H04B 1/26; H04B 2210/006

(57) ABSTRACT

The quantum system can have a quantum signal source configured for generating a first signal and a second signal, the first signal and the second signal being in the frequency domain of between 4 and 300 GHz; the first signal having quantum correlations with the second signal; the quantum signal source having a first port operable to output the first signal and a second port operable to output the second signal; a first transmission line coupled between the quantum signal source and an emitter, the emitter operable to communicate the first signal to a target; a receiver coupled to the target and operable to receive the first signal following an interaction between the first signal and the target; a second transmission line coupled between the second port and the receiver; a first amplifier coupled between the first port and the emitter, the first amplifier operable to induce a gain of at least 10 to the first signal, wherein the first mode is amplified at least twice as much as the second mode between the quantum signal source and the receiver and the receiver being sensitive to the quantum correlations between the first signal and the second signal.

### BACKGROUND

Electromagnetic field oscillations, such as those associated to electromagnetic waves, have been used to convey signals for decades. Radar, metrology and telecommunications are common examples of potential applications. In radar applications, the signal is emitted by an operator in the orientation of a potential target, travels within a media such as air, and is reflected back by the target when one is present within range. The reception of the reflected signal by the operator can lead to the detection of the target, and, can provide certain information about the target, such as the distance between the target and the emitter. Some non-destructive testing techniques operate on a similar principle, and associated electromagnetic field oscillations can travel in a portion of a part to be inspected acting as a media. In telecommunications, a signal can be emitted by a first operator, the signal can be received and encoded by the target (e.g. a second operator), and returned the first operator. The reception of the returned signal can allow to decode the communication. Electromagnetic waves propagate in empty space and may also be used in aerospace applications where empty space acts as a media.

While the possible means of using and conveying electromagnetic oscillation based signals are vast and numerous, there always remains room for improvement. For instance, sensitivity and reliability may constitute concerns, and such concerns may be more easily addressed in some portions of the electromagnetic spectrum than in other portions of the electromagnetic spectrum. For instance, the way electromagnetic waves are produced, the way the interact with matter, and therefore their range of practical applications, depends on the frequency, which is inversely related to the wavelength. Emitting antennas may be more efficient when sized as a function of the wavelength. Moreover, different wavelengths may travel more or less easily in various media, such as the earth's atmosphere. Indeed, radio waves in the kHz-MHz range may travel more easily around obstacles like mountains and follow the contour of the earth, by diffracting and refracting, and interact only very slightly with air, allowing to travel very far in the atmosphere, whereas microwaves in the GHz range, or optical frequencies (e.g. infrared or visible) in the THz range and higher, may bend or diffract much less, and be limited to a line of sight, and some wavelengths are absorbed by air and can lose power quickly with distance. Accordingly, equipment used in relation with radio waves is typically unusable for microwave frequencies, and vice-versa; equipment used in relation with light is typically unusable for microwave and radio frequencies, and so forth. For such reasons, e.g. equipment, interaction, or propagation related, many specific application can benefit from the selection of a particular band of frequencies amongst the entire spectrum of electromagnetic oscillations.

### SUMMARY

Quantum physics has seen a significant growth in development over the last decades, and has paved the way to the generation of new quantum states such as pairs of electromagnetic field waves which can have quantum correlations with one another. In one example, elements of a pair can be entangled to one another, and thus be highly correlated to one another, but in another example, other quantum correlations than entanglement, such as quantum discord, may exist between elements of the pair. Entanglement is a quantum property in which the individual quantum states of each element of the pair are indefinite until measured, and the act of measuring one determines the result of the other. More broadly, Quantum discord is a measure of nonclassical correlations between two elements of a quantum pair and includes correlations of quantum physical effects but does not necessarily involve entanglement. Entanglement and quantum discord can be consumed to encode information that can only be accessed by coherent quantum interactions. Quantum discord has been recognized as being more robust against loss and noise. It was found that some applications such as radar and secure communications for instance, could benefit of using pairs of signals having quantum correlations, particularly in the microwave portion of the electromagnetic spectrum.

In one example, a process referred to as spontaneous parametric down-conversion (SPDC) can be used as a quantum resource to generate a pair of two entangled random thermal noise signals, referred to as quantum two-mode squeezed states (QTMS). Taking into consideration significant recent advances in microwave quantum superconducting circuits, and in particular of Josephson parametric amplifiers (JPAs), it was found that QTMS can be generated in the microwave portion of the electromagnetic spectrum. In some situations, even though entanglement may become lost such as due to the presence of signal loss and/or added noise, some degree of quantum correlations such as quantum discord may remain. Indeed, using quantum states of microwaves to interrogate a target (e.g. microwave quantum illumination) in a radar application using JPAs, quantum correlations can be obtained from post-processing of heterodyne measurement records of the quadratures of both signals, in a process which will be referred to herein as quantum-enhanced noise radar. However, sources of QTMS, such as JPAs in the microwave domain, can have relatively low output powers and require amplification in order to be suitably used in practical applications. In the case of quantum-enhanced noise radar for instance, higher power may be required to increase detectable range or to speedup the detection process. Power can be increased by amplification, but amplification unavoidably imparts additional noise which is not correlated. It was found that amplifying both correlated signals symmetrically may lead to rapid collapse of quantum correlations features such as entanglement. It was found, however, that in some applications, using asymmetric amplification could address such challenges and allow to achieve practical workability. Indeed, some applications do not require the same level of amplification between the two signals.

In accordance with one aspect, there is provided a method of interrogating a target, the method comprising: generating a first signal and a second signal at a quantum signal source, the first signal having quantum correlations with the second signal; propagating the second signal to a receiver; propagating the first signal to a receiver via a target, the target altering the first signal, said propagating the first signal including amplifying the first signal at least 2 times more between the quantum signal source and the target than any amplifying of the second signal between the quantum signal source and the receiver; receiving the second signal and the altered first signal at the receiver; and performing a correlation measurement between the received second signal and the received altered first signal.

The signals can be embodied as electromagnetic field oscillations at frequencies between 1 and 300 GHz, such as between 4 and 100 GHz and perhaps more typically between 4 and 12 GHz. The signals will typically be carried in a controlled manner by a transmission line such as a conductor trace, a cable, etc., although they may also, especially the first signal, be emitted by a suitable device such as an antenna to be propagated more freely at some point in a media such as free space, air, or in a material of a part undergoing non-destructive testing for instance, in which case it can also be received by an antenna following the free propagation segment. Alternately, a signal can be emitted in a manner to propagate within a telecommunications network which may have 2 or more nodes.

Performing the correlation measurement can be realized in a variety of ways, such as by measuring the cross-correlation or the cross-covariance between the received second signal and the received altered first signal.

In accordance with another aspect, there is provided a quantum system comprising: a quantum signal source configured for generating a first signal and a second signal, the first signal and the second signal being in the frequency domain of between 4 and 300 GHz; the first signal having quantum correlations with the second signal; the quantum signal source having a first port operable to output the first signal and a second port operable to output the second signal; a first transmission line coupled between the quantum signal source and an emitter, the emitter operable to communicate the first signal to a target; a receiver coupled to the target and operable to receive the first signal following an interaction between the first signal and the target; a second transmission line coupled between the second port and the receiver; a first amplifier coupled between the first port and the emitter, the first amplifier operable to induce a gain of at least 10 to the first signal, wherein the first signal is amplified at least twice as much as the second signal between the quantum signal source and the receiver, the receiver being sensitive to the quantum correlations between the first signal and the second signal.

Many further features and combinations thereof concerning the present improvements will appear to those skilled in the art following a reading of the instant disclosure.

### DESCRIPTION OF THE FIGURES

In the figures,

FIG. 1 is a schematic view of an example of a quantum system;

FIG. 2 is a schematic view of an example of a quantum two-mode squeezed state (QTMS) source which can be used in the quantum system of FIG. 1;

FIG. 3A is a graph depicting the entanglement measure (symplectic eigenvalue of the partially transposed covariance matrix) v-for the asymmetric case versus the power gain GB and amplifier noise NB, for the fixed value of r=0.5; the boundary for entanglement is 1, with red showing entanglement and blue showing no entanglement;

FIG. 3B are graphs depicting the symplectic eigenvalue v_for the asymmetric loss case versus the loss in dB (η=10^{-loss/10}) and the added noise due to the loss for the fixed value of r=0.5; in the left graph, the added noise is parametrized as the physical temperature T; in the right-hand side graph, it is parameterized by Nₗ (with 1 corresponding to T=0); the boundary for entanglement from the PPT criterion is v_=1, with red showing entanglement and blue showing no entanglement. Similar to the case of asymmetric gain, we see that for T=0, the entanglement only disappears asymptotically as the loss goes to infinity;

FIG. 4 are graphs presenting a demonstration of a quantum enhancement in the amount of correlations with identical power constraints to a classical source, where the LHS of Eq. (23) is plotted against the channel transmittance n and the amplifier gain with squeezing and noise values appearing in the insets; contour lines indicate the upper bound of the achievable quantum enhancement over a classical source with noise value Nc indicated by the contour level for each graph;

FIG. 5 are graphs depicting the symplectic eigenvalue for the case of cascaded amplifier gain and loss, both applied to one channel asymmetrically, as function of the loss in dB (η=10−loss/10) and the added noise due to the loss for the fixed value of r=0.5 and loss temperature T=1K; in the top plot, we assume the amplifier is quantum limited (NA=1); in the bottom plot, we assume the amplifier has a small amount of excess noise (NA=1.1); the boundary for entanglement from the PPT criterion is 1, with red showing entanglement and blue showing no entanglement;

FIG. 6 is a block diagram providing a general representation of an amplified source quantum two-mode squeezed states (A-QTMS source);

FIG. 7 is a graphical representation of entanglement bound v_<1 from the PPT criterion over G_{A}, G_{B} of a QTMS under two-sided amplification in the limit of quantum-limited amplification with N_{A}=N_{B}=1 and infinite squeezing r→∞;

FIG. 8 is a phase diagram illustrating the 2-sided amplification domain in {GA,GB} where a quantum enhancement can be had, even in the presence of amplification noise, transmission losses and additive noise, for system parameters: r=0.5, η=0.3, Nl=100, N_{A}=10, N_{B}=50, NcA=1000, NcB=1000;

FIG. 9 is a schematic representation of a communication system employing an amplified source of QTMS;

FIG. 10 is a schematic representation of a bi-static remote sensing system employing an amplified source of QTMS; and

FIG. 11 are schematic representations of three different example receiver/decoder schemes.

### DETAILED DESCRIPTION

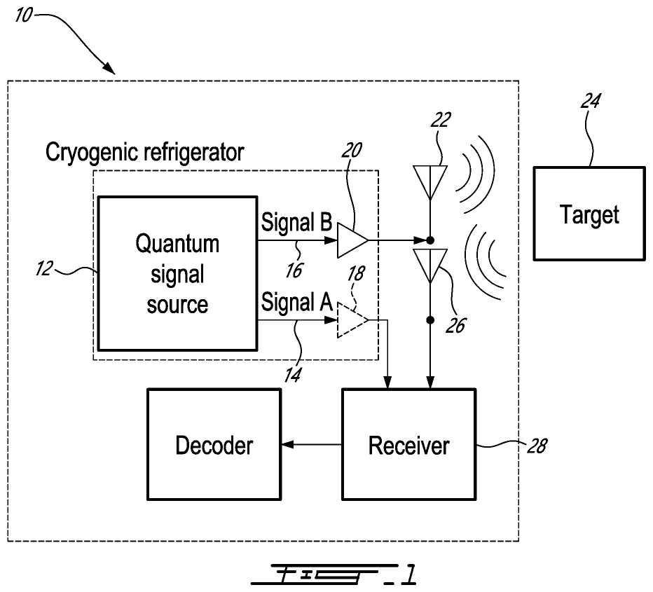

FIG. 1 shows an example of a quantum system 10 having a quantum signal source 12 configured to generate two signals 14, 16 having quantum correlations, such as two quantum-entangled signals, referred to herein as signal A 14 and signal B 16. A first amplifier 20, referred to herein as amplifier B, is configured to amplify signal B 16 prior to emission via an emitter antenna 22. Travelling as electromagnetic waves, signal B interacts with a “target” 24, which may be a radar target, a component to be analyzed with non-destructive testing, or a telecommunications encoder to name a few potentials examples, before returning back to the quantum system 10 where it is picked up by a receiving antenna 26 via which it is conveyed to a receiver 28. Signal A 14 is conveyed more directly to the receiver 28, optionally via amplification by a second amplifier 18, referred to herein as amplifier A, but without interacting with the target 24.

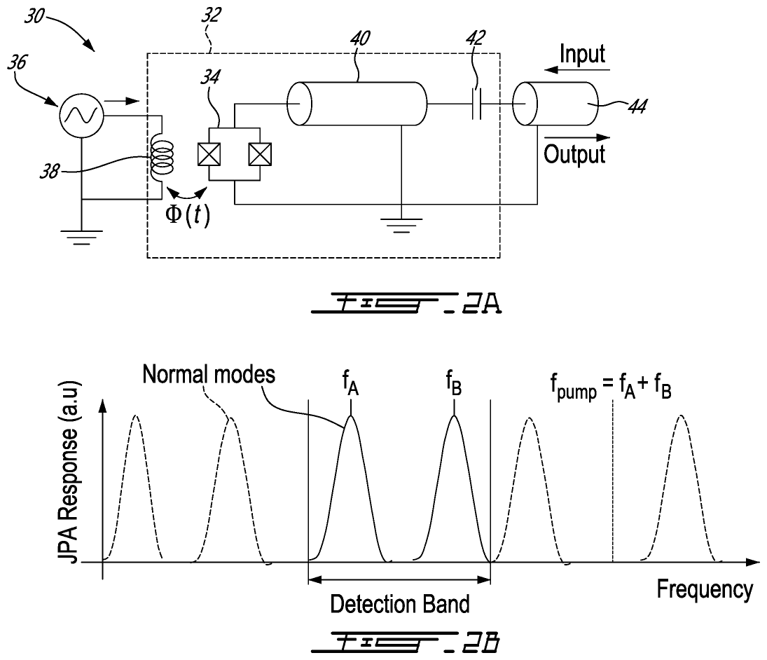

In one example, the quantum signal source 12 can be a Quantum Two Mode Squeezed State (QTMS) source 30, an example of which is presented in FIG. 2A. As seen in FIG. 2A, the QTMS source 30 can be embodied with Josephson Parametric Amplifiers (JPAs) 32 in this embodiment. More specifically, a JPA 32 can be embodied using a superconducting quantum interference device (SQUID) 34 operating at cryogenic temperatures. A pump 36 operating at a pump frequency (fₚᵤₘₚ) can be used to drive a coil 38, the coil 38 driving an AC flux at the pump frequency (a DC component may or may not be present). A resonator 40 and a coupling capacitor 42 are coupled to the SQUID 34, between an input and an output of a transmission line 44. The JPA 32 may have a plurality of resonances, or normal modes, a number of which are represented by Gaussian curves in FIG. 2B. The pump frequency can be selected in a manner to excite two of the resonance frequencies, which will be referred to herein as f_{A} and f_{B}. The activated resonance frequencies f_{A} and f_{B} can have a sum equal to fₚᵤₘₚ from the point of view of conservation of energy. The activated resonance frequencies f_{A} and f_{B} can be selected to be “close” to one another, in a manner to occupy a relatively limited “detection band”, which can be covered by the receiver. f_{A} can be outputted as the first signal, and f_{B} can be outputted as the second signal, or vice versa, though some practical considerations may motivate a choice of one or the other as the first signal in some embodiments. To operate in QTMS mode, the input of the transmission can be left to be a quantum vacuum.

Let us now modelize such a scenario in a manner to provide a more detailed example embodiment.

As an introduction, and a way to introduce notation, we will first derive the quantum enhancement for a quantum noise radar based on an ideal two-mode squeezed states.

The quantum state of the microwave fields produced by a QTMS source can be fully characterized by measuring the covariance matrix of the corresponding in-phase, I, and quadrature, Q, voltages. This is a general property of so-called Gaussian states, which include the classical thermal and coherent states, as well as squeezed states. I and Q are common concepts in modern wireless and radar technology. In the quantum realm, they are the canonically conjugate variables of the electromagnetic field, analogous to position and momentum in a mechanical system. If we consider the signals A and B, the covariance matrix is of the form V′=E[xx^{T}] where x=[I_{A}, Q_{A}, B, Q_{B}]^{T} and E[·] denotes the expectation value. Generally, the signal quadratures of both signals depend on time such that the covariance matrix can be computed for signals measured at different times.

In order to quantify quantum properties such as entanglement, the measured covariance matrix V′ must be calibrated and normalized in units of absolute photon number, yielding a scaled covariance matrix, V. QTMS being zero-mean Gaussian random signals, their covariance matrix has the general form

$$V = ( \begin{matrix}{P}_{A} & 0 & {C}_{Q} cos ϕ & {C}_{Q} sin ϕ \\ 0 & {P}_{A} & {C}_{Q} sin ϕ & - {C}_{Q} cos ϕ \\ {C}_{Q} cos ϕ & {C}_{Q} sin ϕ & {P}_{B} & 0 \\ {C}_{Q} sin ϕ & - {C}_{Q} cos ϕ & 0 & {P}_{B}\end{matrix} ) , \qquad ( 1 a )$$

where P_{A} and P_{B} denote the signal power, C_{Q} denotes the quantum correlation between signals A and B, while φ is the relative phase between signals A and B.

The QTMS source can be characterized by measuring and calibrating the covariance matrix immediately at its outputs. There, signals A and B have identical power P_{A}=P_{B}=P_{Q} and the phase φ=0. In such a case, it is characterized by a single parameter, the squeezing parameter r, such that the total output power in each quadrature (variance) is P_{Q}=cosh (2r) and the quantum correlation is C_{Q}=sinh (2r).

To determine the presence of entanglement in V, we a test known as the positive partial transpose (PPT) can be used, where the degree of entanglement can be quantified by the minimum symplectic eigenvalue, vₘᵢₙ, of the partial transpose of V. A two-mode Gaussian state is entangled (and therefore, quantum) if vₘᵢₙ<1, and is said to be classical if vₘᵢₙ≥1.

A proper reference is the ideal classical correlated state saturating the positive partial transpose (PPT) bound with vₘᵢₙ=1. The optimal classical correlation (C_{c}) in such a state correspond to the output power of one of the signals, P, minus one unit of vacuum noise, or C_{c}=P−1. For a classical source with the same output power as a QTMS source, the optimal classical source will have C_{c}=cosh (2r)−1. With a mind towards fitting data, we define the differenced output power P_{D′}=cosh (2r)−1 and the measured differenced power, P_{D}, with P_{D}/P₀=cosh (2r)−1, where P₀ being a scale factor that includes the system gain. Hence, we can express the correlations as a function of measured power and find the squeezing parameter r as

$$r = \frac{1}{2} {cosh}^{- 1} ( 1 + \frac{{P}_{D}}{{P}_{0}} ) . \qquad ( 1 b )$$

Reciprocally, we can then use the identity sinh (cosh⁻¹(x))=\sqrt{x²−1} to write the quantum correlations

$${C}_{Q} = sinh ( {cosh}^{- 1} ( 1 + \frac{{P}_{D}}{{P}_{0}} ) ) = \sqrt{\frac{{P}_{D}}{{P}_{0}} ( \frac{{P}_{D}}{{P}_{0}} + 2 )} , \qquad ( 2 )$$

and the optimal classical correlations as

$${C}_{C} = \frac{{P}_{D}}{{P}_{0}} . \qquad ( 3 )$$

Ultimately, this allows to define quantum enhancement of the correlations over the classical analogue as

$${Q}_{E} = \frac{{C}_{Q}}{{C}_{C}} = \sqrt{1 + 2 \frac{{P}_{0}}{{P}_{D}}} . \qquad ( 4 )$$

The quantum enhancement of the correlations over a classical analogue with Q_E>1 is known to be the direct consequence of a source capable of generating quantum discord at its outputs.

Here we want to consider the effects of amplifying the quantum signals on their entanglement. We will consider both the symmetric amplification case, where both signals are identically amplified, and the fully asymmetric amplification case, where only one signal is amplified. In both cases, we will assume the signal is generated by an ideal, symmetric para-amp where the variances of the output mode quadratures are all equal and have the value P_{Q} and the covariances are all equal and have the value Co.

### Symmetric Amplification

In the symmetrical case, we consider identical amplifiers of power gain G on both signals emitted by the quantum two-mode squeezing source. We model the amplifiers with the standard operator equation, e.g., for Aₐₘₚ of mode a,

Aₐₘₚ=\sqrt{G}aₒ+\sqrt{G−1}h^{†} (5)

where aₒ is the mode at the output of the para-amp to be amplified (quantum source) and h is the noise operator for the amplifier. This form assures that Aₒᵤₜ obeys the usual commutation relations, but the results don't rely on the details of the amplifier model. From this, we get the simple relations for the powers and correlations at the output of the amplifiers which are

Pₐₘₚ=GP_{Q}+(G−1)N_{A}

Cₐₘₚ=GC_{Q} (6)

where N_{A}=coth (hω/kT_{N}) is the amplifier noise number and T_{N} is the noise temperature. Recalling that the bound for entanglement from the PPT test is P−C<1, we then calculate

Pₐₘₚ−Cₐₘₚ=Gexp(2r)+(G−1)N_{A} (7)
where we assumed the quantum source is ideal and r is the squeezing parameter. As bounds, we can assume infinite squeezing which than gives us the simple entanglement condition:

(G−1)N_{A}<1 (8)

We see then that for a quantum limited amplifier with N_{A}=1, we break entanglement for G>2.

Even if amplifying the quantum signal breaks entanglement, we can still ask if there may be an advantage based on the fact of using quantum-limited amplification. As our classical benchmark we will use our state proposed above, which is a coherent state with added thermal noise. In the context of our noise radar protocol, pair of coherent states would be classically modulated to produce pseudorandom signals which are classically correlated. We write the classical quadrature output power as P_{c}=C_{c}+N_{c}≥N_{c} where C_{c} is the classical correlation and N_{c} is the noise number of the source. To compare our classical benchmark to our amplified quantum source, we will set the two output powers to be equal to that of the classical source that is P_{c}=Pₐₘₚ. Again approximating with the infinite squeezing result of P_{Q}=C_{Q}, we can express the classical covariance as

$${C}_{C} = {GC}_{Q} + ( G - 1 ) {N}_{A} - {N}_{C} = {C}_{amp} + ( G - 1 ) {N}_{A} - {N}_{C} \qquad ( 9 )$$

From this, we get the result that there is a quantum enhancement when the quantum covariance of the amplified quantum source exceeds the classical covariance, i.e. Cₐₘₚ>C_{c}, when

$$( G - 1 ) {N}_{A} < {N}_{C} \qquad ( 10 )$$

That is, a quantum enhancement is achieved if the output noise of the amplifier is lower than the noise of the classical source.

### Asymmetric Amplification

Starting from the symmetric output of the para-amp, we now assume that only the second signal, signal B is amplified by an amplifier with the same form as previously (i.e. amplifier A is non-existent in this simulation), but now with gain G_{B} and noise N_{B}. After this amplification we now have an asymmetric covariance matrix (still in canonical form) described by

$${P}_{A} = {P}_{Q} = cos h ( 2 r ) \qquad ( 11 )$$

$${P}_{B} = {G}_{B} {P}_{Q} + ( G - 1 ) {N}_{B}$$

$${C}_{asy} = \sqrt{{G}_{B}} {C}_{Q} = \sqrt{{G}_{B}} sin h ( 2 r )$$

To test for entanglement we will calculate the symplectic eigenvalue v_of our asymmetric covariance matrix, which is

$${v}_{-} = \overline{P} - \sqrt{δ {P}^{2} + {C}_{asy}^{2}} , \qquad ( 12 )$$

where P̅=(P_{A}+P_{B})/2 and δP=(P_{A}−P_{B})/2. Writing these out we find

$$\overline{P} = \frac{{G}_{B} + 1}{2} {P}_{Q} + \frac{{G}_{B} - 1}{2} {N}_{B} , \qquad ( 13 )$$

$$and$$

$$δ P = - \frac{{G}_{B} - 1}{2} {P}_{Q} - \frac{{G}_{B} - 1}{2} {N}_{B} . \qquad ( 14 )$$

Putting it all together we get

$${v}_{-} = \frac{{G}_{B} + 1}{2} {P}_{Q} + \frac{{G}_{B} - 1}{2} {N}_{B} - {\frac{1}{2} [ {( {G}_{B} - 1 )}^{2} {( {P}_{Q} + {N}_{B} )}^{2} + 4 {G}_{B} {C}_{Q}^{2} ]}^{1 / 2} . \qquad ( 15 )$$

The PPT criterion imposes that the state is entangled if v_<1.

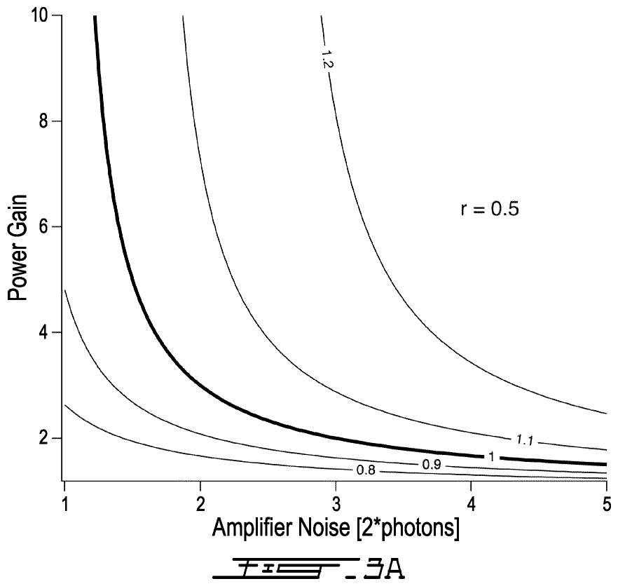

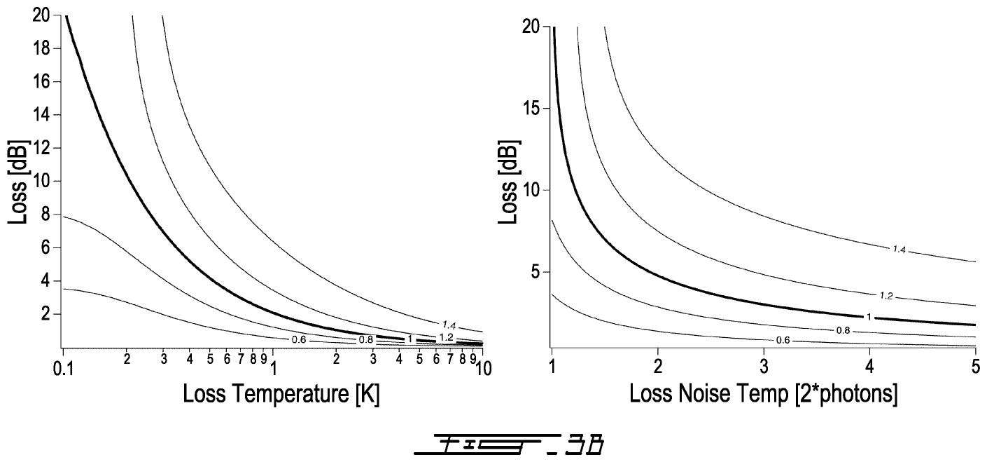

A significant element of this result is that for a quantum-limited amplifier with N_{B}=1 the system remains entangled for arbitrary values of amplification gain G_{B}. That is, in principle, if only one output mode of a quantum two-mode squeezed state is amplified (with a quantum-limited amplifier), we can make it arbitrarily bright while still maintaining entanglement. In FIG. 3A, we plot this function.

### Effect of Loss

Let us now consider the effects of asymmetric channel loss, which we model as an unbalanced beamsplitter with power transmittance n inserted into the path of either the signal or idler. The beamsplitter transformation is then

$${A}_{loss} = \sqrt{η} {a}_{o} + \sqrt{1 - η} v \qquad ( 16 )$$

where v is the annihilation operator of the added noise of the amplifier (the 4th port) as imposed by the fluctuation-dissipation theorem and the preservation of the commutation relation. We assume here that the loss is inserted in the B path and find

$${P}_{A} = {P}_{Q} = cos h 2 r \qquad ( 17 )$$

$${P}_{B} = η {P}_{Q} + ( 1 - η ) {N}_{l}$$

$${C}_{asy} = \sqrt{η} {C}_{Q} = \sqrt{η} sin h ( 2 r )$$

where Nₗ is the noise number of the loss, given by Nₗ=coth (hω/kT) where T is now the physical temperature of the lossy medium. Substituting these values into Eq. (12), we find

$$\overline{P} = \frac{η + 1}{2} {P}_{Q} + \frac{1 - η}{2} {N}_{l} , \qquad ( 18 )$$

$$and$$

$$δ P = \frac{1 - η}{2} ( {P}_{Q} - {N}_{l} ) . \qquad ( 19 )$$

### Putting it all Together we Get for the Symplectic Eigenvalue

$${v}_{-} = \frac{η + 1}{2} {P}_{Q} + \frac{1 - η}{2} {N}_{l} - {\frac{1}{2} [ {( 1 - η )}^{2} {( {P}_{Q} - {N}_{l} )}^{2} + 4 η {C}_{Q}^{2} ]}^{1 / 2} \qquad ( 20 )$$

In FIG. 3B, we plot this function of the loss and temperature. We can make some comments. First, similar to the case of asymmetric gain, we see that for T→0, the entanglement only disappears asymptotically as the loss goes to infinity. At finite temperatures, entanglement vanishes more quickly, but we can observe nonetheless that loss at sub-Kelvin temperatures can be tolerated to a fair degree.

A next question is how amplifier gain and external loss interact. In particular, we can ask whether asymmetrically amplifying the quantum signal before subjecting it to loss can increase the loss threshold. Simply cascading the two models above we find

$${A}_{combo} = \sqrt{η G} {a}_{o} + \sqrt{η ( G - 1 )} {h}^{†} + \sqrt{1 - η} v , \qquad ( 21 )$$

with the same definitions of the operators as above. Applying this gain and loss to the B channel again we find

$${P}_{A} = {P}_{Q} = cos h ( 2 r ) \qquad ( 22 )$$

$${P}_{B} = ( η G ) {P}_{Q} + η ( G - 1 ) {N}_{A} + ( 1 - η ) {N}_{l}$$

$${C}_{asy} = \sqrt{η G} {C}_{Q} = \sqrt{η G} sin h ( 2 r )$$

Writing down an explicit expression for v_is cumbersome but it is straightforward to use these results to calculate the symplectic eigenvalue numerically from Eq. (12). In FIG. 5, we plot some sample results, showing v_as a function of gain and loss. For both plots, we use a fixed value of r=0.5 and a physical loss temperature of T=1K. As an interesting numerical result, we see that, for the case of a quantum-limited amplifier with N_{A}=1, the gain does not affect the value of loss where entanglement is lost. For finite excess amplifier noise (N_{A}>1), we see instead that the amplifier gain generally makes things worse. That is, as we increase the gain, the loss boundary moves to lower loss values.

Even if the entanglement is lost, in some parameter regime of amplifier gain and channel loss, a practical quantum enhancement in the correlations may be had with respect to a comparable classical source of signals. Like before, we consider that the asymmetrically amplified quantum source with loss has the same transmitted power than a comparable classical source with P_{c}=C_{c}+N_{c}=P_{B} and we determine that there is a quantum enhancement if C_{asy}>C_{c}. Considering the effects of the amplification and channel loss on the quantum source, a quantum enhancement can be had if P_{B}−C_{asy}<N_{c}, or more specifically if

$$η G cos h ( 2 r ) - \sqrt{η G} sin h ( 2 r ) + η ( G - 1 ) {N}_{A} + ( 1 - η ) {N}_{l} < {N}_{C} . \qquad ( 23 )$$

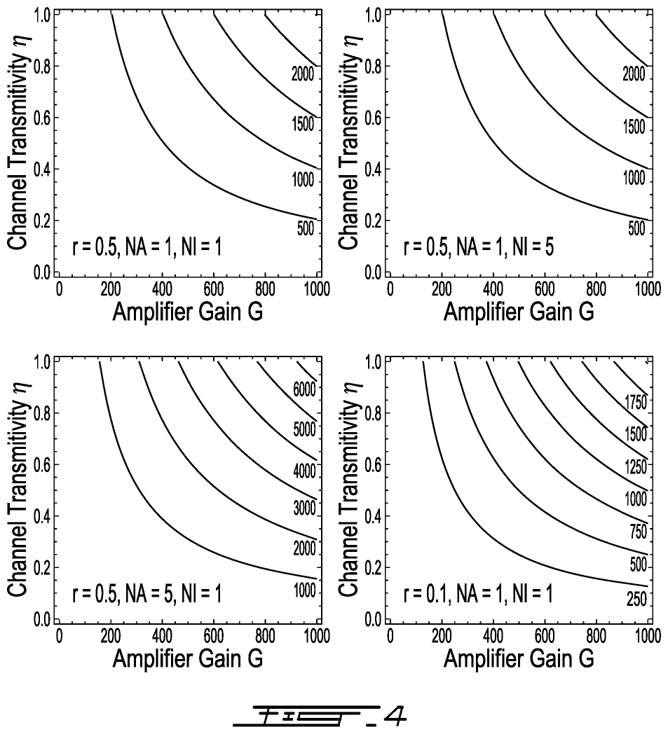

In FIG. 4 we plot the LHS of Eq. 23 as a function of the amplifier gain G and channel transmittance η for different parameter values of the squeezing parameter r, amplifier noise N_{A} and loss noise Nₗ. The contour lines indicate increasing values of the classical noise number N_{c} and represents the upper bound bellow which a quantum enhancement can be had. First, we can see that a quantum enhancement can be had for a wide range of parameter values. Second, that the loss temperature has little effect on the reduction of the enhancement. We evaluate that the effect of the loss temperature becomes important when the loss noise becomes comparable with the classical noise temperature (not shown). Third, the enhancement is very sensitive with respect to the amplifier noise. And finally, we see that a reduction in the quantum squeezing parameter r improves the overall enhancement with respect to the classical case.

That is, a classical source only generates correlated signals for transmitting powers above its noise floor N_{c}. Hence, a quantum source can serve as a correlated signal source for signals that have powers well below the noise floor.

### Generalized 2-Sided Amplification Model

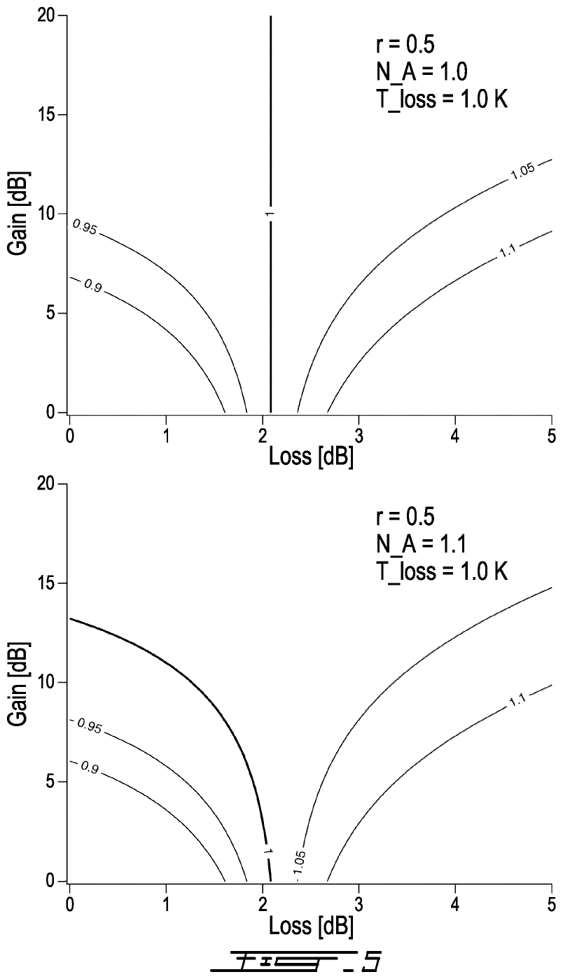

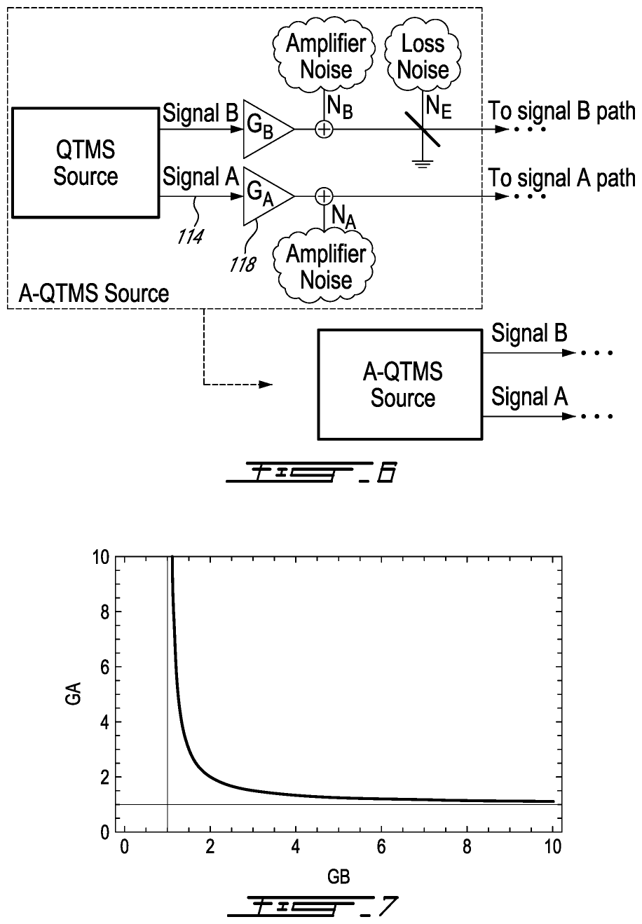

Here we generalize the model to consider the limitations of having 2 amplifiers acting on a two-mode squeezed state, as represented in FIG. 6. We extend the previous model by adding an amplifier 118 with noise on signal A 114 such that:

$${P}_{A} = {G}_{A} cos h ( 2 r ) + ( {G}_{A} - 1 ) {N}_{A} \qquad ( 24 )$$

$${P}_{B} = ( η {G}_{B} ) cos h ( 2 r ) + η ( {G}_{B} - 1 ) {N}_{B} + ( 1 - η ) {N}_{l}$$

$${C}_{asy} = \sqrt{η {G}_{A} {G}_{B}} sin h ( 2 r )$$

Note that the notation has changed a bit to make things clearer: G_{A(B)} and N_{A(B)} refer to the amplifier gain and added noise on signal A(B). To keep the discussion simpler, we did not include loss and additive noise on channel A.

Since the additive noise is detrimental to correlations, the effect of the second amplifier (on signal A) is to reduce the maximal gain on signal B before entanglement is destroyed. To show this simply, we first consider the ideal case of quantum-limited amplifiers with N_{A}=N_{B}=1 with no channel loss and added noise. With the PPT criterion stating that there is entanglement for v_<1, from Eq. (12) we get the following inequality for 2-sided amplification for the state to remain entangled:

$${G}_{B} < \frac{{G}_{A} ( 1 + cos h ( 2 r ) ) - 2}{2 cos {h}^{2} ( r ) ( {G}_{A} - 1 )} , \qquad ( 25 )$$

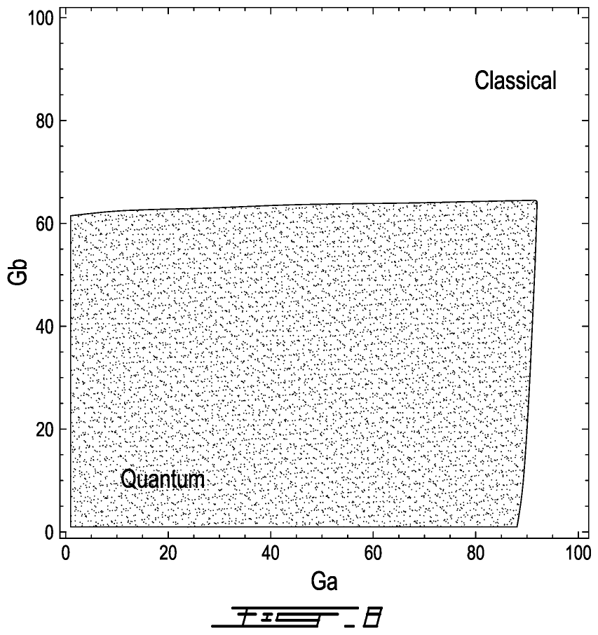

Note that reversing G_{A} and G_{B} gives the maximal gain for G_{A} constrained over G_{B}. The result of this equation is plotted in FIG. 8 and we can see that it is a very sharp function of the amplifier gains. Also, there is no limit to amplification if the amplification is one-sided (ie G_{A}→∞ if G_{B}→1, and vice-versa) and the maximal gain is indeed G_{A}=G_{B}=2 in the symmetric amplification scheme.

We ask that the quantum and classical powers are the same with P_{A}=C_{c}+N_{cA} and P_{B}=C_{c}+NCB while C_{asy}>C_{c}, this means that the following inequalities must be respected simultaneously:

$${P}_{A} - {C}_{asy} < {N}_{cA} and {P}_{B} - {C}_{asy} < {N}_{cB} . \qquad ( 26 )$$

That is, depending on the amount of classical noise on both channels, there exists at least one combination of amplifier gain and noise on both channels that respects both inequalities simultaneously for a given value for a squeezing parameter r. In FIG. 8 we illustrate the amplification domain {G_{A}, G_{B}} over which a quantum enhancement can be had for a selection of system parameters. As we can see, the amplification domain can be quite large and gives a lot of freedom to optimizations.

Accordingly, amplification can be used to increase the transmitted power in order to compensate for channel loss and noise, that is, to achieve a minimal signal-to-noise ratio at the receiver required for the application.

For applications using correlated signals, a balance can be reached between transmitted power and the amount of correlation. The optimal parameters depend on the application requirements, environment and technical contraints.

The amplification gain here is minimally G>1 and is usually found to be in the range of G˜20-40 dB for JPAs operating at or near the quantum-limit. The ideal or maximal gain value depends on, but not limited to, the amplification scheme (1 or 2 sided), amplifier noise, source power, channel loss and added noise. The gain should be set according to the application specifications and to the minimal quantum requirements corresponding to entanglement preservation or to a quantum enhancement.

Quantum microwave devices such as JPAs typically operate at a center frequency in the GHz range, typically in the 2-12 GHz frequency band. Depending on the device configuration and material, the operating frequency can be extended in the few 100 GHz range. Depending on the embodiment, amplification bandwidth can be narrow (<1 MHz) or broad (>1 GHZ).

The amplification stage can be constituted of either one or many amplifiers placed in the chain. In the latter, it is best to have the first amplifier with the least amount of added noise in the chain, as the first amplification stage sets the effective noise characteristics of the chain.

### Applications

Assymetric amplification of signals having quantum correlations can be desirable in a variety of applications. In two example applications presented below in particular, the use of entangled states of microwave signals, and in particular, in the form of quantum two-mode squeezed states, can be beneficial despite the presence of signal losses and additive noise. Has mentioned above, given that QTMS sources may have low power, entanglement-preserving (or minimally correlation-preserving) amplification may be desirable to offset channel losses and improve performance, efficiency, practical distance, etc.

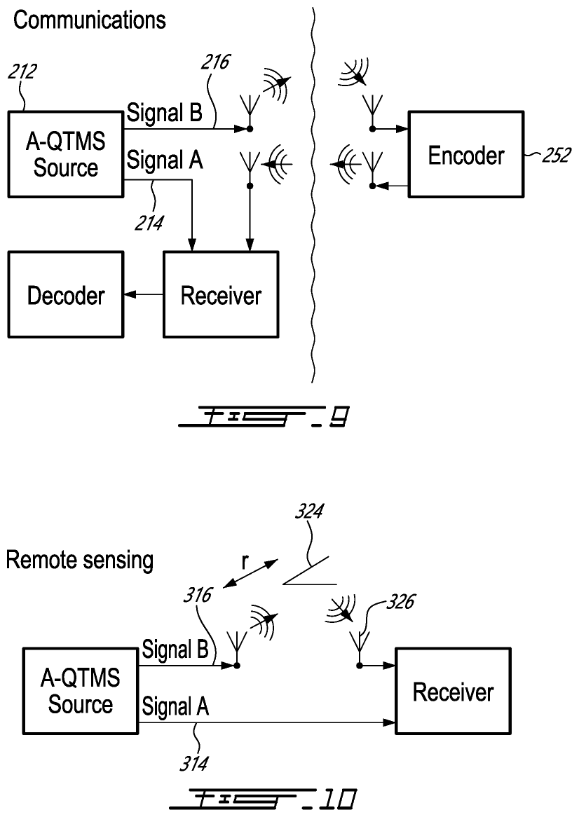

One possible application is secure communication between two users in a covert fashion, ie the transmitted messages have a low-probability of being detected, intercepted and therefore, decoded, an example of which is presented in FIG. 9. In the embodiment presented in FIG. 9, the A-QTMS source 212 is used as a shared resource between the two operators. The first operator generates the QTMS states and shares signal B 216 with the second operator over a public communication channel, while keeping signal A 214. Via an encoder 252, the second operator encodes a message on the received signal and relays the encoded signal back to the first operator. The first operator then performs a correlation measurement of a suitable type between the encoded signal B and signal A in order to extract the encoded message.

The application can have different embodiments. QTMS have been shown to saturate the secret key rate capacity over lossy and noisy communication channels due to entanglement and quantum correlations. Using amplification of QTMS may enable channel loss compensation and therefore improve communication performance over a given distance. Conversely, it may allow for longer distances between the users for the same communication performance.

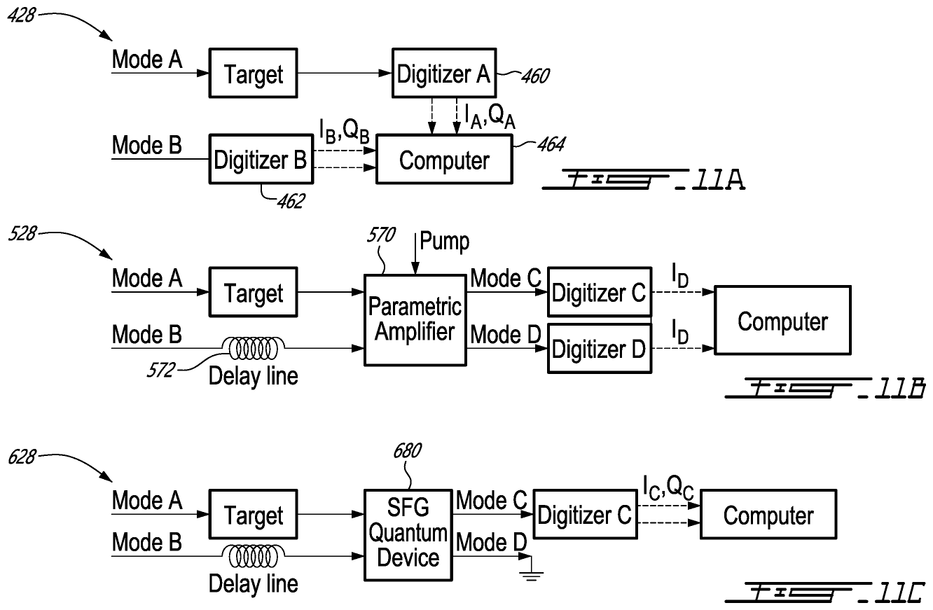

Another possible application is remote sensing. As depicted in FIG. 10, the amplified signal B 316 can be sent towards a distant object (target 324) while signal A 314 is kept in the system. The object affects the incident signals by changing one or many of its characteristics: its amplitude, frequency and/or phase. The transformed and reflected signal is then called the echo. At least part of the echo travels back to the receiving antenna 326. The collected echo and signal A are then processed in the receiver to extract information about the object. A plurality of information of the object can be extracted the analysis of the echo such as, but not limited to: presence or absence, distance, velocity, size, shape or composition. The receiver type and architecture will change depending on the object information to be acquired, but at least a correlation-type measurement between the echo and signal A will be performed. Several repeated measurements may be performed in succession and averaged in order to increase the system's accuracy.

It should be noted that the system could use one (mono-static), two (bi-static, shown) or many (multi-static) antennas to perform the measurement.

This general framework describes radar-type measurements that can be used for non-destructive testing and evaluation (NDT-E) of materials, target detection and ranging (radar) or radar imaging, to name a few examples.

Other potential applications can include, for example, sensing applications such as non-destructive testing, imaging, radar; communications such as exchanging data, exchanging voice, short range, long range, over a network, via an antenna, via a wire; and quantum computing such as improving performance, using the technique to perform quantum bit readout, etc.

In the case of a communications application, for instance, the quantum system can include an apparatus which allows to modulate the source to convey information in the signal. The modulation can be in amplitude, frequency and/or phase for example. In some embodiments, a layer of encoding can be applied on top of the base information in the signal, but this may not be required in some applications.

### Correlation Receivers

Various types of receivers may be used to perform the type of correlation measurement associated to a given application. In many applications, an objective at the receiver can be to search for correlations. More specifically, a first signal can be compared to a second signal, and a peak in similitude between the signals can be an indication of the presence of correlations. Several examples of which will now be presented for the purpose of providing detailed descriptions of potential embodiments. In some examples, for instance, a comparison can be performed digitally on a computer through computation of the cross-correlation of the quadrature voltages of signal A measured at time tA with those of signal B at time tB. The computer can calculate the cross-correlation for a wide range of time delays T=tA−tB and the amplitude of the cross-correlation as a function of the delay time is kept in memory. This process is known as matched filtering. Phase transformation/compensation of the measurement records of mode B can be performed digitally prior to computing the cross-correlation. The measurement process can be repeated a given number of times under identical conditions and the results then averaged over these repeated measurements. Successful detection of the return signal is obtained when the cross-correlation amplitude reaches a certain threshold which may be set by user. In such an example, signal B can be digitized directly at the output of the QTMS source, while signal A can be digitized after reception by a receiving antenna, for example, or otherwise after an interaction with the target.

In a first example, presented in FIG. 11A, a digital matched-filter receiver 428 is used. This type of receiver 428 can be referred to as a heterodyne receiver. In one embodiment, this receiver 428 has two separate and independent digitizers 460, 462, each measuring the two quadratures of the voltage the modes and keeping the digital measurement records in memory. Mode B is digitized ideally directly at the output of the QTMS source, while mode A is digitized after reception by the receiving antenna. The correlation can be performed digitally on a computer 464 through computation of the cross-correlation of the quadrature voltages of mode A measured at time tA with those of mode B at time tB. The computer 464 calculates the cross-correlation for a wide range of time delays T=tA-tB and the amplitude of the cross-correlation as a function of the delay time is kept in memory. This process can be referred to as matched filtering. Phase transformation/compensation of the measurement records of mode B can be performed digitally prior to computing the cross-correlation. The measurement process can be repeated a given number of times under identical conditions and the results then averaged over these repeated measurements. Successful detection of the return signal is obtained when the cross-correlation amplitude reaches a certain threshold which may be set by user.

Such a receiver may be easily implementable and allow for digital control over the signal phase and time delay without the need of imperfect and lossy elements.

In a second example, presented in FIG. 11B, a parametric amplifier (PA) receiver 528 is used. This type of receiver 528 can be interpreted as an analog version of matched-filter receiver, and may rely on recombining modes A and B on a second parametric amplifier at the exact same time, in essence producing and interferometric-type of measurement. The second parametric amplifier effectively mixes modes A and B together through a correlation product. The second parametric amplifier produces two separate noise signals at the two outputs. The variance of each output mode corresponds to the amplitude of the cross-correlation of modes A and B. The variance of a mode can be measured using a digitizer measuring a single voltage quadrature.

The second parametric amplifier may ideally match in frequency and bandwidth the parametric amplifier used as the QTMS source. The second parametric amplifier 570 can use a pump signal to perform the non-linear mixing process. The phase of the pump signal relative to the phase of signal of mode A sets the amplitude of the cross-correlation and hence of the variance of the output signals. Mode B can travel to the receiver through a delay line 572, whose length can be chosen such that mode B arrives simultaneously with mode A at the receiver. Delay line losses, phase mismatch and possibly more crucially, time delay mismatch may severely reduce the performance and practicality of such an analog matched-filter receiver.

In a third example, presented in FIG. 11C, a sum-frequency generation (SFG) receiver 628 can be used. This type of receiver 628 may operate in a similar fashion as the PA receiver 528. It can recombine mode A with a delayed mode B on a non-linear quantum device 680 which performs a sum-frequency generation (SFG) process. That is, the SFG 680 is the exact opposite process occurring in the QTMS source. In the SFG 680 where photons from A and B arriving simultaneously at the quantum device can be spontaneously recombined to create photon in mode C at the output. The frequency of the mode C corresponds to the sum of the frequencies of modes A and B, that is, fC=fA+fB. At the output, the signal in mode C corresponds to a coherent state whose amplitude and phase depend on the amplitude and relative phases of modes A and B at the input.

The SFG process may be somewhat random and have a relatively low efficiency. In addition, the SFG process is not selective and is not directly dependent on the correlations between modes A and B, but rather on the probability of having A and B photons arriving simultaneously. Hence random events such as those occurring under non-ideal conditions (external signal sources from other devices) and under thermal noise may still register. To compensate, the SFG receiver may be provided with several SFG units in series with built-in measurement and feedforward loop to filter-out those spurious events. The SFG receiver may thus be more complex and difficult to implement in practice and non-idealities may strongly inhibit overall performance.

It will be noted that the embodiment presented in FIG. 11A is digital, i.e. the signals are digitalized and the comparison is performed at the receiver typically on the basis of the digital expression of the signals which have been stored in a computer-readable memory which may be transitory or non-transitory, whereas the embodiments presented in FIGS. 11B and 11C are more analog in nature, capitalizing on an interference phenomenon, and may require to adapt the hardware for the signals to arrive simultaneously at the receiver in some embodiments, whereas in the non-transitory memory variant of FIG. 11A, the signals may arrived in a delayed manner.

As can be understood, the examples described above and illustrated are intended to be exemplary only. As exposed above, various modifications and adaptations to the embodiments presented and illustrated are possible. Moreover, expressions should not be interpreted in a limited manner when broader interpretation compliant with the knowledge of persons skilled in the art is possible. For instance, in this specification, the expression receiver is used to refer to equipment used to receive the first and the second signal, but this expression is not intended to imply that the same pieces of hardware will receive both signals. In practice, separate pieces of hardware can be used to digitize each one of the two signals and a computer can be used to perform calculations on the digitized signals to assess the presence or absence of correlation. Similarly, the expression “computer” is not intended to be interpreted in an limitative manner but rather in a general sense of a device having a processor and memory accessible to the processor where instructions to perform functions and other data can be stored in the memory and accessed by the processor for performing the functions on the other data, for instance. In practice, a desktop computer, a laptop computer or a smartphone may be used, as the “computer” to name some examples. Various types of emitters can be used to convey the signal as needed. In some embodiments, the emitter can be located inside the cryogenic refrigerator whereas in other the emitter can be located outside the cryogenic refrigerator. The emitter and the receiver can have corresponding antennas in some embodiments, or share a same antenna in other embodiments. In some alternate example, the target can be a sample located inside a cryogenic refrigerator instead of being outside a cryogenic refrigerator, and the quantum system can be used to characterize the sample at cryogenic temperatures. The scope is indicated by the appended claims.

What is claimed is:

1. A quantum system comprising:
a quantum signal source configured for generating a first signal and a second signal, the first signal and the second signal being in the frequency domain of between 4 and 300 GHz; the first signal having quantum correlations with the second signal; the quantum signal source having a first port operable to output the first signal and a second port operable to output the second signal;
a first transmission line coupled between the quantum signal source and an emitter, the emitter operable to communicate the first signal to a target;
a receiver operable to receive the first signal following an interaction between the first signal and the target, the receiver being sensitive to the quantum correlations between the first signal and the second signal;
a second transmission line coupled between the second port and the receiver; and
a first amplifier coupled between the first port and the emitter, the first amplifier operable to induce a gain of at least 10 to the first signal;
wherein the first mode is amplified at least twice as much as the second mode between the quantum signal source and the receiver.

2. The quantum system of claim 1 further comprising a cryogenic refrigerator enclosing the quantum signal source, the cryogenic refrigerator operable to sustain a temperature of between 50K and 5 mK.

3. The quantum system of claim 2 wherein the target is located outside the cryogenic refrigerator.

4. The quantum system of claim 3 wherein the emitter is located outside the cryogenic refrigerator.

5. The quantum system of claim 1 wherein the quantum signal source is a quantum two-mode squeezed state source, the first signal is a first mode of the QTMS source, the second signal is a second mode of the QTMS source, the QTMS source having a first mode port operable to output the first mode and a second mode port operable to output the second mode.

6. The quantum system of claim 5 wherein the QTMS source further comprises two input ports.

7. The quantum system of claim 5 wherein the first amplifier is coupled to the QTMS source via a circulator.

8. The quantum system of claim 1 wherein the first signal and the second signal are in the frequency domain of 4-100 GHZ.

9. The quantum system of claim 1 wherein the first signal and the second signal are in the frequency domain of 4-12 GHz.

10. The quantum system of claim 1 wherein the gain of the first amplifier is of at least 100, preferably at least 1000, preferably at least 100 000.

11. The quantum system of claim 1 wherein the first amplifier is configured to provide an amplification of at least 20 dB, preferably at least 30 dB, preferably at least 50 dB.

12. The quantum system of claim 1 further comprising a second amplifier coupled between the first amplifier and the emitter.

13. The quantum system of claim 1 further comprising a second amplifier coupled between the second mode port and the receiver, the second amplifier having a gain of at least half of the gain of the first amplifier, preferably less than 1/10.

14. The quantum system of claim 1 wherein the receiver is a heterodyne, digital matched-filter receiver having a first digitizer coupled to the first signal and a second digitizer coupled to the second signal, the first digitizer and the second digitizer being configured for measuring the two quadratures of the voltage the corresponding signal and storing the digital measurement records in a computer-readable memory.

15. The quantum system of claim 14 further comprising a computer configured for computing a cross-correlation of the quadrature voltages of the first signal measured at time tA with those of the second signal measured at time tB.

16. The quantum system of claim 1 further comprising a computer configured for performing a digital correlation of the first signal and the second signal.

17. A method of interrogating a target, the method comprising:
generating a first signal and a second signal at a quantum signal source, the first signal having quantum correlations with the second signal;
propagating the second signal to a receiver,
propagating the first signal to the receiver via the target, including amplifying the first signal at least 2 times more between the quantum signal source and the target than any amplifying of the second signal between the quantum signal source and the receiver, and including the target altering the first signal;
digitizing the second signal and the altered first signal at the receiver; and
performing a correlation measurement between the received second signal and the received altered first signal.

18. The method of claim 17 wherein said performing the correlation measurement includes measuring one of a cross-correlation and a cross-covariance between the received second signal and the received altered first signal.
